(19) United States
(12) Patent Application Publication
(10) Pub. No.: US 2026/0335913 A1
(43) Pub. Date: Oct. 29, 2026

(54) FLUID NOZZLE AND FLUID SYSTEM

(71) Applicant: 3M INNOVATIVE PROPERTIES COMPANY, St. Paul, MN (US)

(72) Inventors: Scott D. Gullicks, River Falls, WI (US); Ryan P. Marrinan, Lino Lakes, MN (US)

(21) Appl. No.: 19/114,299

(22) PCT Filed: Sep. 22, 2023
(86) PCT No.: PCT/IB2023/059412

§ 371 Date: Mar. 21, 2025

Related U.S. Application Data
(60) Provisional application No. 63/376,893, filed on Sep. 23, 2022.

(51) Int. Cl. B05B 7/04; B05B 7/06

(52) U.S. Cl. CPC B05B 7/0408; B05B 7/066

(57) ABSTRACT

A fluid nozzle includes a tube including an inlet, an outlet, a first portion including the outlet, and a second portion including the inlet. The second portion is configured to be selectively and removably connected to a first fluid source. The tube further includes a third portion at least partially surrounding and connected to the second portion. The third portion includes a cylindrical section and at least one first coupling element. The fluid nozzle further includes an adapter configured to be selectively and removably connected to the third portion of the tube. The adapter is configured to be detachably connected to a second fluid source different from the first fluid source. The adapter includes at least one second coupling element configured to at least partially receive the at least one first coupling element of the third portion therein to form a snap-fit connection between the adapter and the third portion.

### TECHNICAL FIELD

The present disclosure generally relates to a fluid system, and in particular, relates to a fluid nozzle for a fluid system.

### BACKGROUND

Vehicles, such as automobiles, typically include multiple external panels that are connected to a frame or a chassis. One or more gaps present between such panels may be filled with a seam sealer to prevent moisture, dirt, and the like from passing through the gaps and into an engine or passenger compartment of the vehicle. Such seam sealers can also provide sound damping to the vehicle. When one or more of these panels need to be replaced, the gaps between the panels are resealed by a technician. Oftentimes, seam seals have a unique look or pattern that is associated with the original manufacturer of the vehicle. When replacing these seam seals, the technician may desire to replicate the look or pattern of the original seam seal.

The ability to replicate an original equipment manufacturer (OEM) applied seam seal may require the use of a spray applicator and materials that work in, or with, a particular type of the spray applicator. This phenomenon may require multiple spray applicators, fluid nozzles, and materials. Spray applicators are typically expensive and may be difficult to clean. Moreover, additional applicators may be needed to brush some material prior to applying a sprayed texture, or a bead pattern.

Conventionally, a dual cartridge system used for spraying a fluid mixture containing two fluid components includes a dual barrel cartridge unit or other source (e.g., five gallon pails, five fifty-five gallon drums) containing the two fluid component, a disposable static mixer which is connected to a fluid nozzle, and an air manifold which is connected to a supply of pressurized air. Alternatively, a single cartridge system used for spraying a single fluid component generally includes a single barrel cartridge unit or other source containing the single fluid component, a fluid nozzle connected to the single barrel cartridge unit, and an air manifold which is connected to a supply of pressurized air. Typically, for single cartridge systems, the static mixer is integral with the fluid nozzle. Hence, such fluid nozzles may not be usable with dual cartridge systems. Overall, fluid nozzles usable with dual cartridge systems are different in design from fluid nozzles usable with single cartridge systems, thereby increasing part numbers.

Currently, seam sealing applications require purchasing of separate fluid nozzles based on a type of application (such as, single cartridge systems and dual cartridge systems), which may lead to confusion and incorrect ordering, and may also lead to longer wait times for completing repairs.

Joints and gaps are typically filled with high viscosity fluids (e.g., using a sealer) for protection against leaks of water, air, etc. For example, gaps between various external panels (e.g., hemmed flanged panels) of a vehicle may be filled with a seam sealer to prevent moisture, dirt, etc., from passing through the gaps. In downstream repair or aftermarket applications, the gaps between such panels may need to be resealed by a technician. However, technicians have a difficult time replicating, or matching, the quality of sealing originally produced through expensive machinery that are programmed to have precise specifications for pressure, flow, volume, temperature, timing, positioning, viscosity, etc.

Possibility for human error (e.g., uneven bead height, width, or uniformity) in the field or in a repair shop increases especially with inexperienced technicians. Implementation often falls short of original equipment manufacturers capabilities, and this mismatch may be easily observed, such as in a repair assessment or insurance context. Therefore, there is a need for improved techniques to reproduce sealing that do not add time or material costs to repair or aftermarket restoration practices.

Current sealant applicators are non-rotatable, i.e., have inconsistent cross-section of an outlet of the sealant applicator with change in an orientation of the sealant applicator. Further, the current sealant applicators may not allow a user to hold the sealant applicator comfortably while applying the sealant and adjust for the numerous contours and shapes of the panels on which the sealant is being applied to.

Vehicles, such as automobiles typically include multiple external panels that are connected to a frame or chassis. Gaps between these panels can be filled with a seam sealer to prevent moisture, dirt, etc., from passing through the gaps and into engine and/or passenger compartments of the vehicle. In some cases, such seam sealers may also provide sound damping to the vehicle. When one or more of the panels need to be replaced, the gaps between such panels may be resealed by a user. Furthermore, when replacing the seam seals, the user may desire to replicate a look or pattern of original seam seals.

There are a variety of seam sealers available that have different compositions and viscosities. Conventional fluid nozzles may not be suitable for use with the different seam sealers. That is, conventional fluid nozzles may be specifically designed and suitable for use with a single seam sealer product. Further, conventional fluid nozzles may be unable to replicate a look or pattern of original seam seals when not used with the seam sealer that they are specifically designed for.

Therefore, there is a need for a fluid nozzle that is suitable for use with a variety of different seam sealers having different viscosities. Further, there is a need for a fluid nozzle that is able to replicate a look or pattern of original seam seals regardless of a difference in viscosities of different seam sealers.

Joints and gaps are typically filled with a seam sealer for sealings against leaks (e.g., of water, air, etc.). For example, gaps between various external panels (e.g., hemmed flanged panels) of a vehicle may be filled with the seam sealer to prevent moisture, dirt, etc., from passing through the gaps. In downstream repair or aftermarket applications, the gaps between such panels may be resealed by a technician. However, the technicians may have difficulty replicating or matching the quality of an original sealing.

In some cases, there may be a requirement of a wide and/or flat application of a material of the seam sealer to replicate the original sealing having a wide and/or flat appearance. In such applications, tooling or brushing of the applied material in order to achieve the wide and/or flat appearance may lead to air entrapment or contamination prior to curing of the seam sealer. This may also negatively impact paint application at a later point.

### SUMMARY

In a first aspect, the present disclosure provides a fluid nozzle. The fluid nozzle includes a tube including a first tube end and a second tube end opposite to the first tube end. The tube extends along a tube axis defined between the first tube end and the second tube end. The tube includes an inlet defined at the first tube end. The tube includes an outlet defined at the second tube end. The tube further includes a fluid passageway disposed within the tube and extending from the inlet to the outlet. The tube further includes a first portion including the outlet. The first portion extends from the second tube end towards the first tube end along the tube axis. The first portion at least partially defines the fluid passageway therein. The tube further includes a second portion including the inlet. The second portion extends from the first portion to the first tube end along the tube axis. The second portion at least partially defines the fluid passageway therein. The second portion is configured to be selectively and removably connected to a first fluid source. The tube further includes a third portion extending from the first tube end towards the second tube end along the tube axis. The third portion at least partially surrounds and is connected to the second portion. The third portion includes a cylindrical section extending along a length of the third portion and at least one first coupling element disposed on the cylindrical section. The fluid nozzle further includes an adapter configured to be selectively and removably connected to the third portion of the tube when the first fluid source is disconnected from the second portion of the tube. The adapter defines an adapter channel that is in fluid communication with the fluid passageway when the adapter is connected to the third portion of the tube. The adapter is configured to be detachably connected to a second fluid source different from the first fluid source. The adapter includes a first adapter end, a second adapter end opposite to the first adapter end, an adapter axis extending between the first adapter end and the second adapter end, an inner surface, and an outer surface. The adapter is configured to at least partially receive the third portion of the tube therein through the first adapter end. The adapter includes at least one second coupling element disposed on the inner surface proximal to the first adapter end and extending angularly about the adapter axis. The at least one second coupling element is configured to at least partially receive the at least one first coupling element of the third portion therein to form a snap-fit connection between the adapter and the third portion. The tube is rotatable relative to the adapter about the tube axis upon connection with the adapter.

In a second aspect, the present disclosure provides a method of using the fluid nozzle of the first aspect. The method includes interchangeably connecting the second portion of the tube to a mixer of the first fluid source. The method further includes connecting the mixer to a first vessel of the first fluid source and a second vessel of the first fluid source. The method further includes mixing a first fluid from the first vessel and a second fluid from the second vessel in the mixer to form a fluid mixture. The method further includes directing the fluid mixture into the inlet of the fluid nozzle. The method further includes ejecting the fluid mixture through the outlet of the fluid nozzle.

In a third aspect, the present disclosure provides a method of using the fluid nozzle of the first aspect. The method includes interchangeably connecting the third portion of the tube to the adapter. The method further includes connecting the adapter to the second fluid source. The method further includes directing a fluid from the second fluid source into the inlet of the fluid nozzle via the adapter channel. The method further includes ejecting the fluid through the outlet of the fluid nozzle.

In a fourth aspect, the present disclosure provides a fluid system. The fluid system includes a fluid nozzle. The fluid nozzle includes a tube including a first tube end and a second tube end opposite to the first tube end. The tube extends along a tube axis defined between the first tube end and the second tube end. The tube includes an inlet defined at the first tube end. The tube includes an outlet defined at the second tube end. The tube further includes a fluid passageway disposed within the tube and extending from the inlet to the outlet. The tube further includes a first portion including the outlet. The first portion extends from the second tube end towards the first tube end along the tube axis. The first portion at least partially defines the fluid passageway therein. The tube further includes a second portion including the inlet. The second portion extends from the first portion to the first tube end along the tube axis. The second portion at least partially defines the fluid passageway therein. The tube further includes a third portion extending from the first tube end towards the second tube end along the tube axis. The third portion at least partially surrounds and is connected to the second portion. The third portion includes a cylindrical section extending along a length of the third portion and at least one first coupling element disposed on the cylindrical section. The fluid nozzle further includes an adapter configured to be selectively and removably connected to the third portion of the tube. The adapter defines an adapter channel that is in fluid communication with the fluid passageway when the adapter is connected to the third portion of the tube. The adapter includes a first adapter end, a second adapter end opposite to the first adapter end, an adapter axis extending between the first adapter end and the second adapter end, an inner surface, and an outer surface. The adapter is configured to at least partially receive the third portion of the tube therein through the first adapter end. The adapter includes at least one second coupling element disposed on the inner surface proximal to the first adapter end and extending angularly about the adapter axis. The at least one second coupling element is configured to at least partially receive the at least one first coupling element of the third portion therein to form a snap-fit connection between the adapter and the third portion. The tube is rotatable relative to the adapter about the tube axis upon connection with the adapter. The fluid system further includes a first fluid source and a second fluid source different from the first fluid source. The first fluid source and the second fluid source are interchangeably connected to the fluid nozzle. The first fluid source is detachably connected to the second portion of the tube. The second fluid source is detachably connected to the adapter.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1A is a perspective view of a fluid nozzle including a tube and a manifold, according to an embodiment of the present disclosure;

FIG. 1B is a bottom view of the tube associated with the fluid nozzle of FIG. 1A, according to another embodiment of the present disclosure;

FIG. 2 is a schematic cross-sectional view of a fluid system including the fluid nozzle of FIG. 1A, a mixer, and a first fluid source, according to an embodiment of the present disclosure;

FIG. 3 is a perspective view of the tube and an adapter associated with the fluid nozzle of FIG. 1A, according to an embodiment of the present disclosure;

FIG. 4 is a perspective view of an adapter associated with the fluid nozzle of FIG. 3, according to an embodiment of the present disclosure;

FIG. 5 is a schematic cross-sectional view of the fluid nozzle of FIG. 3, according to an embodiment of the present disclosure;

FIG. 6 is a perspective view of an adapter associated with the fluid nozzle of FIG. 2, according to another embodiment of the present disclosure;

FIG. 7 is a schematic cross-sectional view of a fluid system including the fluid nozzle of FIG. 3, the adapter of FIG. 4, and a second fluid source, according to another embodiment of the present disclosure;

FIG. 8 is a flowchart for a method of using the fluid nozzle, according to an embodiment of the present disclosure;

FIG. 9 is a flowchart for a method of using the fluid nozzle, according to another embodiment of the present disclosure;

FIG. 10A is a perspective view of a tube and the manifold of FIG. 1A, according to an embodiment of the present disclosure;

FIG. 10B is a cross-sectional view of a fluid system including the tube of FIG. 10A, the mixer and fluid source of FIG. 2, and the manifold of FIG. 1A, according to an embodiment of the present disclosure;

FIG. 10C is a cross-sectional view of the mixer and the tube taken along a view perpendicular to the flow direction, according to an embodiment of the present disclosure;

FIG. 11A is a perspective view of a fluid system including a tube and the manifold of FIG. 1A, according to an embodiment of the present disclosure;

FIG. 11B is a cross-sectional view of a fluid system including the tube of FIG. 11A, the manifold of FIG. 1A, and a second fluid source of FIG. 7, according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the following disclosure, the following definitions are adopted.

As used herein, all numbers should be considered modified by the term “about”. As used herein, “a,” “an,” “the,” “at least one,” and “one or more” are used interchangeably.

The term “about”, unless otherwise specifically defined, means to a high degree of approximation (e.g., within +/−5% for quantifiable properties) but again without requiring absolute precision or a perfect match.

As used herein as a modifier to a property or attribute, the term “generally” or “typically”, unless otherwise specifically defined, means that the property or attribute would be readily recognizable by a person of ordinary skill but without requiring absolute precision or a perfect match (e.g., within +/−20 % for quantifiable properties).

The term “substantially”, unless otherwise specifically defined, means to a high degree of approximation (e.g., within +/−10% for quantifiable properties) but again without requiring absolute precision or a perfect match.

Terms such as same, equal, uniform, constant, strictly, and the like, are understood to be within the usual tolerances or measuring error applicable to the particular circumstance rather than requiring absolute precision or a perfect match.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, when a first material is termed as “similar” to a second material, at least 90 weight % of the first and second materials are identical and any variation between the first and second materials includes less than about 10 weight % of each of the first and second materials.

As used herein, “at least one of A and B” should be understood to mean “only A, only B, or both A and B”.

As used herein, the recitations of numerical ranges by endpoints include all numbers subsumed within that range as well as the endpoints (e.g., 1 to 5 includes 1, 1.5, 2, 2.75, 3, 3.80, 4, 5, etc.).

The term “coupled” or “connected” may include direct physical connections between two or more components, or indirect physical connections between two or more components that are connected together by one or more additional components. For example, a first component may be coupled to a second component by being directly connected together or by being connected by a third component. Unless specified or limited otherwise, the terms “attached,” “connected,” “coupled,” and variations thereof, are used broadly and encompass both direct and indirect attachments, connections, and couplings.

As used herein, the term “configured to” and like is at least as restrictive as the term “adapted to” and requires actual design intention to perform the specified function rather than mere physical capability of performing such a function.

As used herein, the term “resilient deformation” refers to an elastic deformation of a component or a portion of the component upon application of a force. The component, when resiliently deformed, may have a deformed state. The component may not plastically deform in the deformed state. The component may return to its undeformed state upon removal of the force. The force may be applied by another component. An extent of the elastic deformation may depend upon a magnitude of the force applied.

In general, the present disclosure provides various embodiments of a fluid nozzle and a fluid system that includes the fluid nozzle. The fluid nozzle can include a tube and a manifold disposed around tube. Typically, original equipment manufacturer (OEM) seam-sealing techniques require time-consuming manual processes to provide seam seals that resemble original factory-applied seam seals. Such processes include using hand tools to physically create specific textures and patterns by manually changing the appearance. Further, such processes include the use of combs, modified plastic body filler spreaders, Scotch Brite™ scuff pads, or other tooling after dispensing sealer onto the surface; physically altering the dispensing through movements of the applicator, adjustment of air pressure using a trigger of a pneumatic applicator, or application of physical pressure of a manual applicator. Other techniques can also include, but are not limited to, cutting or manipulating the dispensing nozzles or selection of various sealing materials being utilized.

Conventionally, a dual cartridge system used for spraying a fluid mixture containing two fluid components includes a dual barrel cartridge unit or other source (e.g., five gallon pails, five fifty-five gallon drums) containing the two fluid component, a disposable static mixer which is connected to a fluid nozzle, and an air manifold which is connected to a supply of pressurized air. Alternatively, a single cartridge system used for spraying a single fluid component generally includes a single barrel cartridge unit or other source containing the single fluid component, a fluid nozzle connected to the single barrel cartridge unit, and an air manifold which is connected to a supply of pressurized air. Typically, for single cartridge systems, the static mixer is integral with the fluid nozzle. Hence, such fluid nozzles may not be usable with dual cartridge systems. Overall, fluid nozzles usable with dual cartridge systems are different in design from fluid nozzles usable with single cartridge systems, thereby increasing part numbers. Currently, seam sealing applications require purchasing of separate fluid nozzles based on a type of application (such as, single cartridge systems and dual cartridge systems), and may lead to confusion and incorrect ordering as well as longer wait times for completing repairs.

Therefore, there exists a need for a fluid nozzle that may be interchangeably connected to single cartridge systems as well as dual cartridge systems, thereby reducing part numbers and increasing efficiency of fluid systems that include fluid nozzles.

The present disclosure provides a fluid nozzle. The fluid nozzle includes a tube including a first tube end and a second tube end opposite to the first tube end. The tube extends along a tube axis defined between the first tube end and the second tube end. The tube includes an inlet defined at the first tube end. The tube includes an outlet defined at the second tube end. The tube further includes a fluid passageway disposed within the tube and extending from the inlet to the outlet. The tube further includes a first portion including the outlet. The first portion extends from the second tube end towards the first tube end along the tube axis. The first portion at least partially defines the fluid passageway therein. The tube further includes a second portion including the inlet. The second portion extends from the first portion to the first tube end along the tube axis. The second portion at least partially defines the fluid passageway therein. The second portion is configured to be selectively and removably connected to a first fluid source. The tube further includes a third portion extending from the first tube end towards the second tube end along the tube axis. The third portion at least partially surrounds and is connected to the second portion. The third portion includes a cylindrical section extending along a length of the third portion and at least one first coupling element disposed on the cylindrical section. The fluid nozzle further includes an adapter configured to be selectively and removably connected to the third portion of the tube when the first fluid source is disconnected from the second portion of the tube. The adapter defines an adapter channel that is in fluid communication with the fluid passageway when the adapter is connected to the third portion of the tube. The adapter is configured to be detachably connected to a second fluid source different from the first fluid source. The adapter includes a first adapter end, a second adapter end opposite to the first adapter end, an adapter axis extending between the first adapter end and the second adapter end, an inner surface, and an outer surface. The adapter is configured to at least partially receive the third portion of the tube therein through the first adapter end. The adapter includes at least one second coupling element disposed on the inner surface proximal to the first adapter end and extending angularly about the adapter axis. The at least one second coupling element is configured to at least partially receive the at least one first coupling element of the third portion therein to form a snap-fit connection between the adapter and the third portion. The tube is rotatable relative to the adapter about the tube axis upon connection with the adapter.

The fluid nozzle of the present disclosure may be used for dispensing high viscosity materials. The fluid nozzle as described herein may be interchangeably used with single cartridge systems and dual cartridge systems. More particularly, the present disclosure provides a modular fluid nozzle that may be quickly and easily connected to a mixer by a press-fit. The mixer may be in turn connected to a dual barrel cartridge unit. Alternatively, the modular fluid nozzle may be quickly and easily connected to the adapter by a snap-fit. Further, the adapter may be threadedly connected to a single barrel cartridge unit. As the modular fluid nozzle may be connected with two types of fluid systems, costs associated with handling and manufacturing of fluid nozzles with different part numbers may be eliminated. Further, the fluid nozzle may be disposable, thereby eliminating time required for cleaning and additional costs associated with cleaning solutions. Moreover, the fluid nozzle may be connectable with different designs of air manifolds and nozzle spray tips.

Further, the fluid nozzle of the present disclosure may reduce the number of applicators (and more specifically, fluid nozzles) that may be required to perform seam sealing applications to replicate OEM look and appearance, while increasing application efficiency, reducing waste, and creating a unique, no clean up solution for both single cartridge systems and dual cartridge systems.

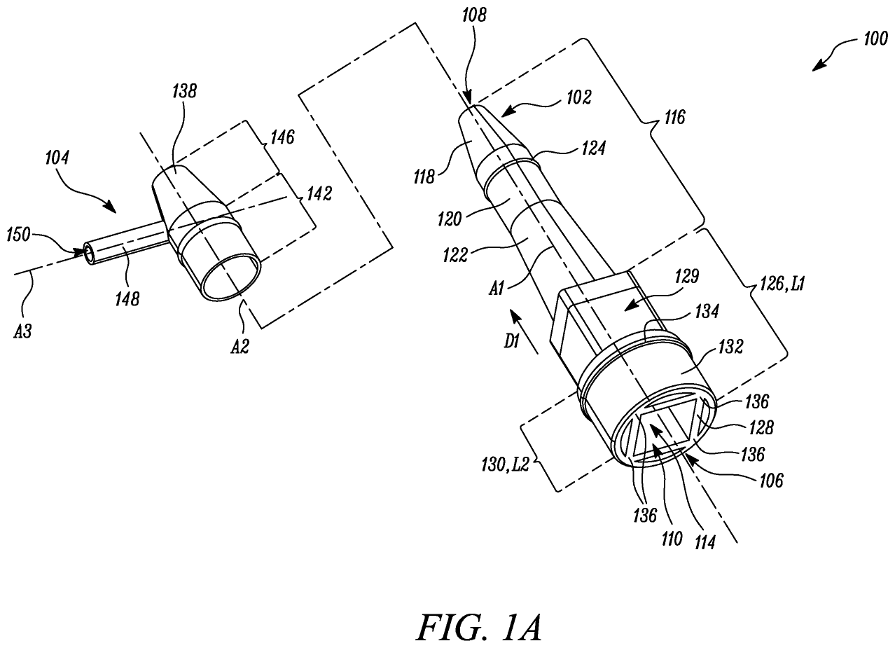

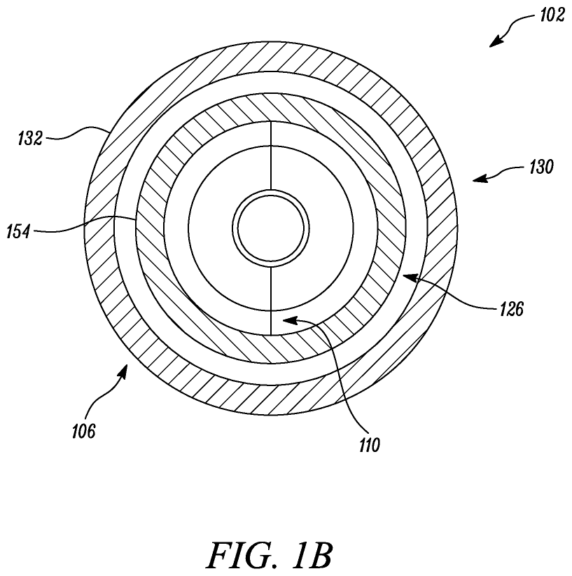

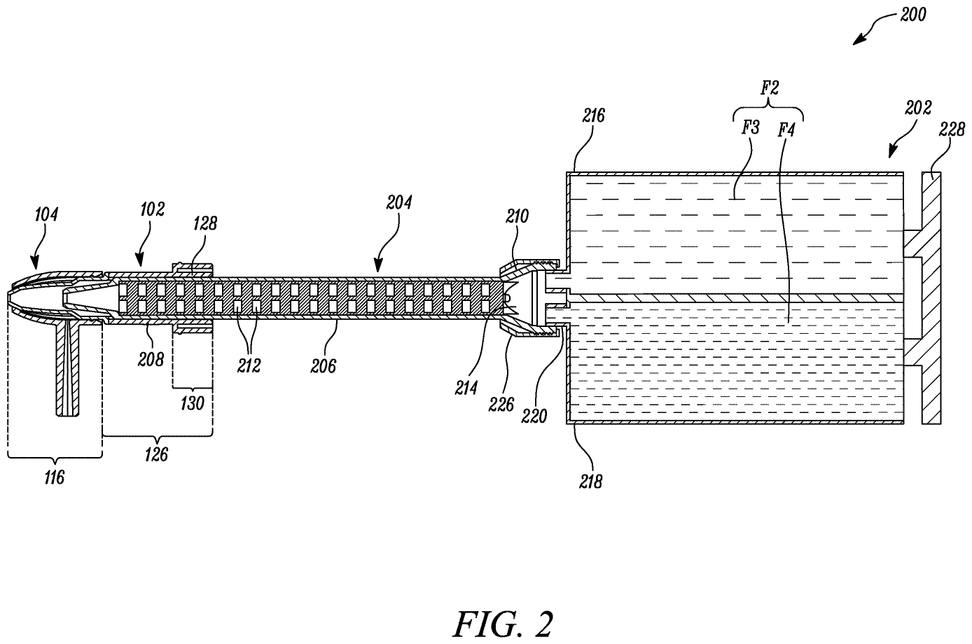

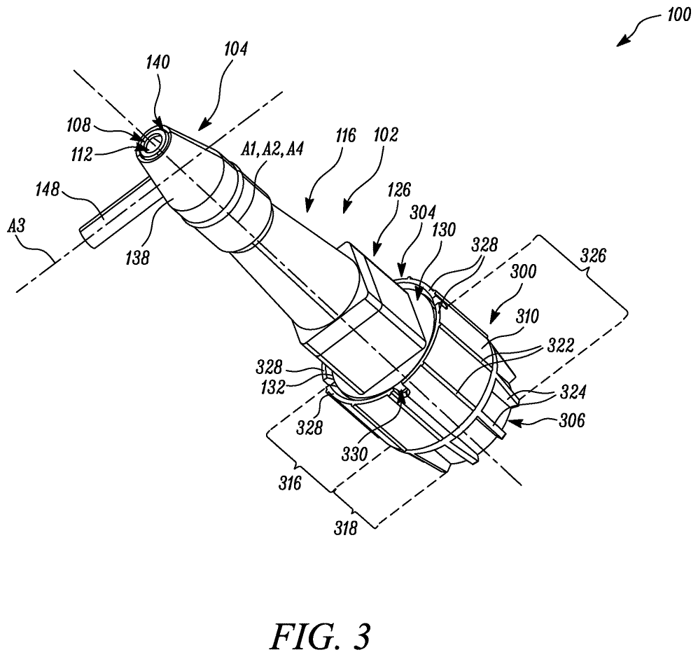

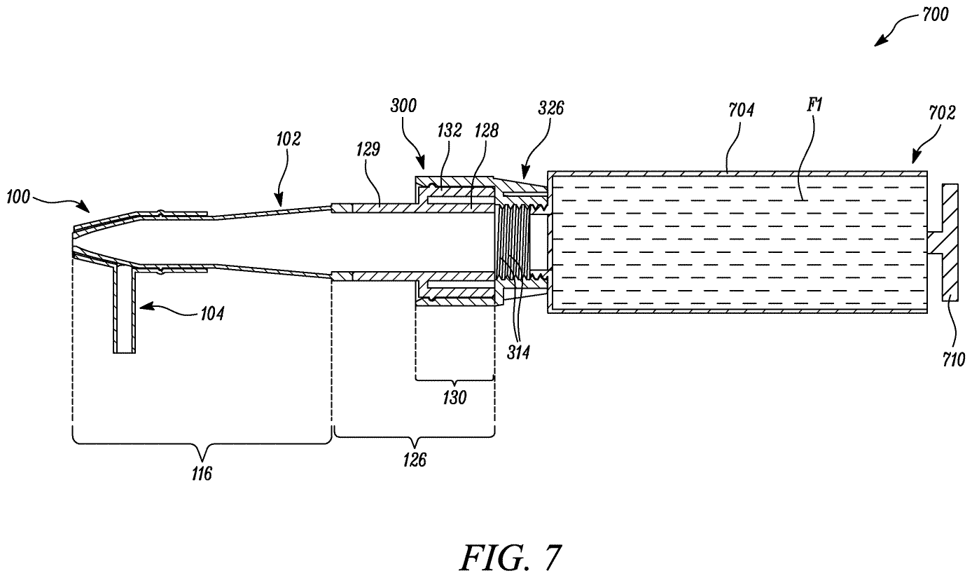

Referring now to Figures, FIG. 1A illustrates a perspective view of a fluid nozzle 100. The fluid nozzle 100 includes a tube 102. The fluid nozzle 100 may also include a manifold 104 selectively connectable to the tube 102. In some examples, the tube 102 is a single integral component. The tube 102 includes a first tube end 106 and a second tube end 108 opposite to the first tube end 106. The tube 102 extends along a tube axis Al defined between the first tube end 106 and the second tube end 108. The tube 102 includes an inlet 110 defined at the first tube end 106. A fluid F1 (see FIG. 7) or a fluid mixture F2 (see FIG. 2) may be received within the tube 102 via the inlet 110. The term “fluid mixture” as used herein may include a combination of two different fluids that may be mixed by a mixer 204 (shown in FIG. 2) connected to the tube 102. The tube 102 further includes an outlet 112 (shown in FIG. 3) defined at the second tube end 108. The fluid F1 or the fluid mixture F2 may exit the tube 102 via the outlet 112. The tube 102 further includes a fluid passageway 114 disposed within the tube 102 and extending from the inlet 110 to the outlet 112.

The tube 102 further includes a first portion 116 including the outlet 112. The first portion 116 extends from the second tube end 108 towards the first tube end 106 along the tube axis A1. The first portion 116 at least partially defines the fluid passageway 114 therein. In some embodiments, the first portion 116 at least partially tapers in a flow direction DI from the first tube end 106 to the second tube end 108. Specifically, the first portion 116 may include a first tapering portion 118 having a tapering cross-section along the flow direction D1, a second uniform portion 120 having a uniform cross-section, and a third tapering portion 122 having a tapering cross-section along the flow direction D1. Each of the first tapering portion 118, the second uniform portion 120, and the third tapering portion 122 may include a circular cross-section. Alternatively, the first tapering portion 118, the second uniform portion 120, and the third tapering portion 122 may include any other cross-section, such as a square cross-section. In other examples, the first portion 116 may include a circular cross-section along a section of the first portion 116, and the first portion 116 may include a square cross-section along a remaining section of the first portion 116. Further, the first tapering portion 118 of the first portion 116 may include the outlet 112. Moreover, the second uniform portion 120 may include a continuous rib 124 extending therefrom. In other examples, the second uniform portion 120 may include more than one continuous rib (similar to the continuous rib 124), without any limitations.

The tube 102 further includes a second portion 126 including the inlet 110. The second portion 126 extends from the first portion 116 to the first tube end 106 along the tube axis A1. The second portion 126 includes wall 129 having a polygonal shape 128 along a length L1 of the second portion 126. The second portion 126 at least partially defines the fluid passageway 114 therein. The second portion 126 is configured to be selectively and removably connected to a first fluid source 202 (shown in FIG. 2). In some embodiments, the polygonal shape 128 of the second portion 126 is square. In some other embodiments, the polygonal shape 128 of the second portion 126 may be rectangular, hexagonal, triangular, and so forth. The second portion 126 may be integral with the first portion 116. In some examples, a cross-sectional area of the second portion 126 may be greater than an average cross-sectional area of the first portion 116. In some embodiments, the second portion 126 may be configured to receive a section of the mixer 204 in a sealing manner. In at least one embodiment, the first portion 116 can have a different cross-sectional shape relative to the second portion 126. For example, the first portion 116 can be circular and the second portion 126 can be rectangular/square. In at least one embodiment, the wall 129 can extend from the border between the first portion 116 and the second portion 126 to the second tube end 108.

The tube 102 further includes a third portion 130 extending from the first tube end 106 towards the second tube end 108 along the tube axis A1. The third portion 130 at least partially surrounds and is connected to the second portion 126. The third portion 130 includes a cylindrical section 132 extending along a length L2 of the third portion 130 and at least one first coupling element 134 disposed on a wall of the cylindrical section 132. The at least one first coupling element 134 is disposed proximal to the second portion 126 and is distal from the first tube end 106. In the illustrated embodiment of FIG. 1A, the third portion 130 includes a single first coupling element 134. However, the third portion 130 may include multiple first coupling elements (similar to the first coupling element 134), without any limitations. In the illustrated embodiment of FIG. 1A, the at least one first coupling element 134 includes an annular rib. Specifically, the first coupling element 134 is a continuous annular rib extending about the tube axis A1. Alternatively, the at least one first coupling element 134 may include one or more tabs or projections extending from the third portion 130, one or more bosses, and the like. It should be noted that the present disclosure is not limited by a shape or a design of the first coupling element 134.

Further, in some examples, the length LI of the second portion 126 may be greater than the length L2 of the third portion 130. In some examples, the length L1 of the second portion 126 may be about twice the length L2 of the third portion 130. Further, the polygonal shape 128 of the second portion 126 and the cylindrical section 132 of the third portion 130 may be co-axial with each other. In some embodiments, the third portion 130 is connected at least to each vertex 136 of the polygonal shape 128 of the second portion 126 along the length LI of the third portion 130. The second portion 126 may be integral with the third portion 130.

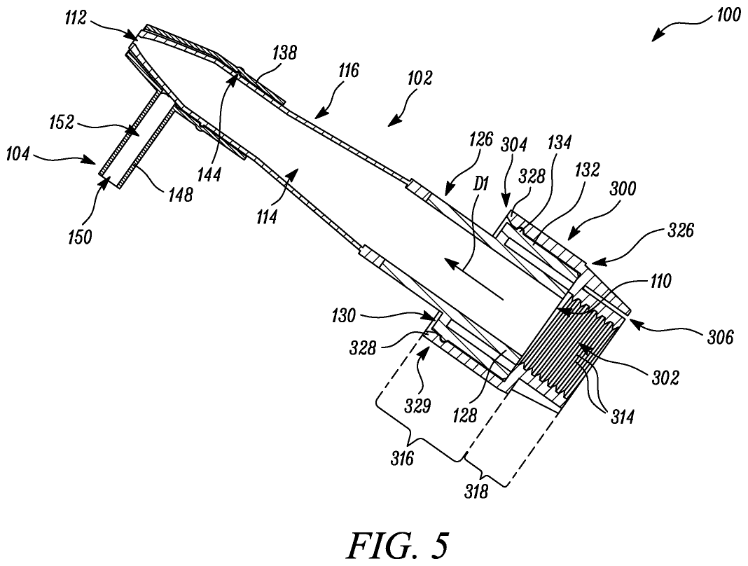

In some embodiments, the fluid nozzle 100 includes the manifold 104 configured to be detachably connected to the first portion 116 of the tube 102 by a snap-fit connection. The manifold 104 may include a first tubular portion 138 extending along a first axis A2 and configured to at least partially receive the first portion 116 of the tube 102 therein. The first tubular portion 138 may define an air outlet 140 (shown in FIG. 3) that is disposed around the outlet 112 of the tube 102. The outlet 112 may be concentrically disposed within the air outlet 140. The first tubular portion 138 may include a first section 142. The first section 142 includes a uniform cross-section. Further, the first section 142 is similar in shape to the second uniform portion 120 of the first portion 116, such that when the manifold 104 is connected to the first portion 116, the first section 142 may be disposed around the second uniform portion 120. Further, the first section 142 may include a circumferential groove 144 (shown in FIG. 5) that receives the continuous rib 124 of the second uniform portion 120 to form the snap-fit connection between the first portion 116 and the manifold 104. During an assembly of the tube 102 with the manifold 104, the continuous rib 124 may compress which may facilitate firm engagement of the manifold 104 and the tube 102 in a fluid tight assembly. In some examples, the manifold 104 and the tube 102 may be connected to one another prior to shipping to a customer, thereby facilitating use of the fluid nozzle 100 by the customer. Furthermore, the first tubular portion 138 may include a second section 146. The second section 146 includes a tapering cross-section. Further, the second section 146 is similar in shape to the first tapering portion 118 of the first portion 116, such that when the manifold 104 is connected to the first portion 116, the second section 146 is disposed around the first tapering portion 118.

The fluid nozzle 100 may further include a second tubular portion 148 extending from the first tubular portion 138 along a second axis A3 inclined to the first axis A2. In some cases, the second axis A3 may be perpendicular to the first axis A2. The second tubular portion 148 may define an air inlet 150 disposed in fluid communication with the first tubular portion 138. The second tubular portion 148 may be designed for quick attachment to a pressurized air source (not shown), via an air supply hose (not shown). The first and second tubular portions 138, 148 may together define an air passageway 152 (shown in FIG. 5) between the air inlet 150 and the air outlet 140, such that when connected to the air source, pressurized air may enter the manifold 104 via the air inlet 150, flow around the first portion 116, and exit the manifold 104 via the air outlet 140. In some examples, the manifold 104 may include a plurality of apertures (not shown) through which the pressurized air may discharge to atomize the fluid F1 or the fluid mixture F2 being discharged from the tube 102.

FIG. 1B illustrates a bottom view of the tube 102, according to another embodiment of the present disclosure. In the illustrated embodiment of FIG. 1B, the second portion 126 of the tube 102 includes a circular shape 154 along the length LI (see FIG. 1A) of the second portion 126. The circular shape 154 of the second portion 126 may be configured to receive a section of a mixer (not shown) for removably connecting the tube 102 with the mixer. Further, the circular shape 154 may be concentrically disposed within the cylindrical section 132. The circular shape 154 may be radially spaced apart from the cylindrical section 132. Accordingly, the circular shape 154 may be disconnected from the cylindrical section 132 along the length L2 (see FIG. 1A) of the third portion 130.

FIG. 2 illustrates a schematic cross-sectional view of a fluid system 200, according to an embodiment of the present disclosure. The fluid system 200 includes the fluid nozzle 100 of FIG. 1A, the mixer 204, and the first fluid source 202. The mixer 204 may be embodied as a static mixing device. In at least one embodiment, the mixer 204 is a static mixing nozzle commercially available from 3M Company (Saint Paul, MN, USA). The tube 102 is configured to partially receive the mixer 204. More particularly, the second portion 126 of the tube 102 is configured to slidably receive the mixer 204 therein. Further, the mixer 204 includes an elongated, mixer tube 206. The mixer tube 206 may define a first mixer end 208 and a second mixer end 210. A shape of the mixer tube 206 corresponds with the polygonal shape 128 of the second portion 126. Accordingly, in the illustrated embodiment of FIG. 2, the mixer tube 206 has a polygonal shape that corresponds to the polygonal shape 128 of the second portion 126. In the illustrated embodiment of FIG. 2, the mixer tube 206 includes a square shape. Alternatively, the mixer tube 206 may include a circular shape that corresponds to the circular shape 154 (see FIG. 1B) of the second portion 126.

It should be noted that, when the fluid nozzle 100 is connected to the mixer 204, the fluid nozzle 100 is not rotatable relative to the mixer 204. In such embodiments, the mixer 204 may have to be rotated relative to the first fluid source 202 for positioning the manifold 104 in a desired orientation. The mixer tube 206 may engage with the second portion 126 in a sealing manner to prevent fluid leakage therethrough. Further, when the mixer 204 is connected with the tube 102, the first mixer end 208 may be disposed within the second portion 126. The mixer 204 may include a plurality of baffle elements 212 to thoroughly mix materials passing through the mixer tube 206. Furthermore, the mixer 204 may be connected to the first fluid source 202 at the second mixer end 210. Moreover, the mixer tube 206 may define a mixing chamber 214 at the first mixer end 208. In at least one embodiment, the tube 102 does not include the plurality of baffle elements.

In the illustrated embodiment of FIG. 2, the first fluid source 202 is embodied as a dual barrel cartridge unit. The first fluid source 202 is detachably connected to the second portion 126 of the tube 102. The first fluid source 202 may include a first vessel 216 configured to contain a first fluid F3 and a second vessel 218 configured to contain a second fluid F4. The first and second fluids F3, F4 can include any suitable material or materials, e.g., seam sealers, epoxies, foams, adhesives (e.g., one or two-part adhesives), fillers, etc. Further, any suitable seam sealing materials may be utilized, e.g., one-part and two-part seam sealers, urethane sealers, modified saline polymer sealers, two-part epoxy sealers, one-part and two-part acrylic sealers, viscus one-part and two-part moisture sealants, ultra-violet cure (UV-cure) sealants, blue-light-cure sealants, heat activated sealants, etc. Furthermore, any suitable adhesives may be utilized, e.g., one-part and two-part acrylic adhesives, etc. In one or more embodiments, the first and second fluids F3, F4 form the fluid mixture F2 that may include a seam sealing composition adapted to seal one or more seams disposed between panels of a vehicle or boat, or to seal seams present on interior or exterior surfaces of buildings.

Further, the first fluid source 202 may include a cylindrical projection 220 that is in fluid communication with each of the first and second vessels 216, 218. The first fluid source 202 may include a plunger 228. The plunger 228 may be used to force the first and second fluids F3, F4 towards the mixer 204. Alternatively, the first fluid source 202 may not include the plunger 228, and the first and second fluids F3, F4 may be forced towards the mixer 204 by applying pressure on the first and second vessels 216, 218, e.g., by squeezing the first and second vessels 216, 218.

In some examples, the mixer 204 may be connected to the first fluid source 202 by a retaining nut 226. In such examples, each of the mixer tube 206 and the cylindrical projection 220 may include external threads (not shown) that may engage with internal threads (not shown) of the retaining nut 226 for connecting the mixer 204 with the first fluid source 202. In another embodiment, the mixer 204 may have internal threads (not shown) that may couple with the first fluid source 202 directly. In yet another embodiment, the mixer 204 may be connected to the first fluid source 202 by a press-fit. It should be noted that the present disclosure is not limited by a technique of connecting the mixer 204 with the first fluid source 202.

The fluid system 200 may be coupled with an applicator gun (not shown) for accomplishing a seam sealing application. The applicator gun may include any conventional sprayable seam sealer applicator gun such as those manufactured by 3M Company (Saint Paul, MN). The applicator gun may include rods that may push the plunger 228 of the first fluid source 202 for directing the first and second fluids F3, F4 towards the fluid nozzle 100. Further, the applicator gun may be in communication with the air source. The applicator gun may be further connected to the manifold 104 by the air supply hose. A movement of the rods and a rate of air supply into the manifold 104 may be controlled by the applicator gun. The applicator gun may have a trigger. A partial squeeze of the trigger to a first position may allow passage of air towards the manifold 104. Further, a full squeeze of the trigger to a second position activates the rods to push the first and second fluids F3, F4 towards the mixer 204. The mixer 204 may mix the first fluid F3 from the first vessel 216 and the second fluid F4 from the second vessel 218 in the mixer 204 to form the fluid mixture F2. The fluid mixture F2 may be directed into the fluid nozzle 100 via the inlet 110. Further, the fluid mixture F2 may be ejected through the outlet 112 of the fluid nozzle 100.

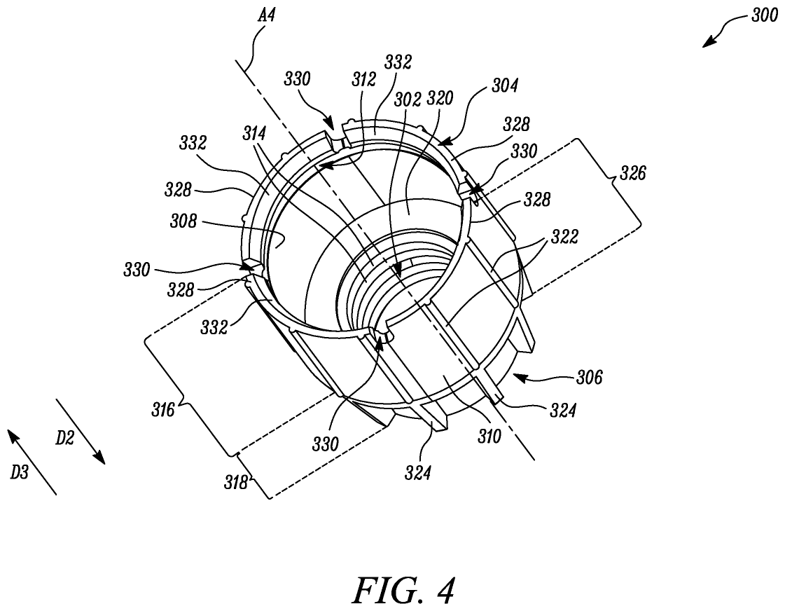

Referring now to FIG. 3, the fluid nozzle 100 further includes an adapter 300 configured to be selectively and removably connected to the third portion 130 of the tube 102 when the first fluid source 202 (see FIG. 2) is disconnected from the second portion 126 of the tube 102. The adapter 300 includes a generally circular cross-section that corresponds to a circular cross-section of the cylindrical section 132 of the third portion 130. The adapter 300 defines an adapter channel 302 (shown in FIGS. 4 and 5) that is in fluid communication with the fluid passageway 114 when the adapter 300 is connected to the third portion 130 of the tube 102. The adapter 300 is configured to be detachably connected to a second fluid source 702 (shown in FIG. 7) different from the first fluid source 202. The adapter 300 includes a first adapter end 304, a second adapter end 306 opposite to the first adapter end 304, an adapter axis A4 extending between the first adapter end 304 and the second adapter end 306, an inner surface 308 (shown in FIG. 4), and an outer surface 310. The adapter 300 is configured to at least partially receive the third portion 130 of the tube 102 therein through the first adapter end 304.

As shown in FIG. 4, the adapter 300 includes at least one second coupling element 312 disposed on the inner surface 308 proximal to the first adapter end 304 and extending angularly about the adapter axis A4. Referring to FIGS. 1A and 4, the at least one second coupling element 312 is configured to at least partially receive the at least one first coupling element 134 of the third portion 130 therein to form a snap-fit connection between the adapter 300 and the third portion 130. The adapter 300 includes a single second coupling element 312 herein. However, the adapter 300 may include multiple second coupling elements (similar to the second coupling element 312). In some embodiments, the at least one second coupling element 312 is a continuous groove extending angularly by 360 degrees about the adapter axis A4. In other embodiments, the at least one second coupling element 312 may include a plurality of second coupling elements that may be circumferentially spaced apart from each other. For example, the at least one second coupling element 312 may include a discontinuous groove. Alternatively, the at least one second coupling element 312 may include a combination of elements, such as, wedges, annular shoulders, projections, and the like, that may allow coupling of the tube 102 with the adapter 300. In some embodiments, the at least one second coupling element 312 may include one or more L-shaped grooves 329 that may receive a corresponding first coupling element 134 of the third portion 130 for coupling the tube 102 with the adapter 300. It should be noted that the present disclosure is not limited by a shape or a design of the second coupling element 312. In some embodiments, the first coupling element 134 may include a groove and the second coupling element 312 may include an annular rib, a projection, a boss, and the like. It should be noted that the adapter 300 and the tube 102 may be detachably connected to each other by any complementary set of coupling elements.

Further, the tube 102 is rotatable relative to the adapter 300 about the tube axis Al upon connection with the adapter 300. The first coupling element 134 and the second coupling element 312 may form a fluid-tight connection between the tube 102 and the adapter 300, while allowing the tube 102 to rotate relative to the adapter 300 about the tube axis A1.

Referring to FIGS. 4 and 5, the adapter 300 may include one or more internal threads 314 extending from the second adapter end 306. The one or more internal threads 314 of the adapter 300 may be configured to be threadably connected to the second fluid source 702 (shown in FIG. 7). In some embodiments, the adapter 300 includes a wide portion 316 disposed proximal to the first adapter end 304 and extending along the adapter axis A4. In some embodiments, the adapter 300 further includes a narrow portion 318 extending along the adapter axis A4 from the second adapter end 306 and including the one or more internal threads 314. The narrow portion 318 may include the adapter channel 302 that is in fluid communication with the fluid passageway 114 when the adapter 300 is connected to the tube 102. The adapter channel 302 is further disposed in fluid communication with the second fluid source 702 upon connection of the adapter 300 with the second fluid source 702. The adapter channel 302 may therefore fluidly communicate the fluid passageway 114 of the tube 102 with the second fluid source 702 upon connection of the adapter 300 with the tube 102 and the second fluid source 702. In some embodiments, the adapter 300 further includes a stepped portion 320 connecting the narrow portion 318 to the wide portion 316.

Referring again to FIG. 4, in some embodiments, the adapter 300 includes a plurality of longitudinal ribs 322 angularly spaced apart from each other about the adapter axis A4. Each of the plurality of longitudinal ribs 322 may extend from the first adapter end 304 towards the second adapter end 306 along the adapter axis A4. The longitudinal ribs 322 may be disposed on the wide portion 316 of the adapter 300. In some embodiments, the adapter 300 further includes a plurality of tapered ribs 324 angularly spaced apart from each other and disposed on the outer surface 310. Each of the plurality of tapered ribs 324 may extend from the second adapter end 306 towards the first adapter end 304 along the adapter axis A4 and tapers in a direction D2 from the first adapter end 304 to the second adapter end 306. The tapered ribs 324 may be disposed on the narrow portion 318 of the adapter 300.

In some embodiments, the adapter 300 further includes an adapter body 326 and a plurality of flexible castellations 328 extending from the adapter body 326 along the adapter axis A4 and disposed at the first adapter end 304. The wide portion 316 extends from the stepped portion 320 up to the first adapter end 304, and includes the plurality of flexible castellations 328. Further, the adapter body 326 is defined by the narrow portion 318 and a section of the wide portion 316, and excludes the plurality of flexible castellations 328. In some embodiments, the plurality of flexible castellations 328 are angularly spaced apart from each other about the adapter axis A4 and define a plurality of slots 330 therebetween. Furthermore, each of the plurality of flexible castellations 328 may be configured to deform at least outwardly relative to the adapter axis A4 during the connection of the third portion 130 with the adapter 300. Moreover, in some embodiments, the at least one second coupling element 312 is disposed adjacent to the plurality of flexible castellations 328 opposite to the first adapter end 304.

In some embodiments, a number of the plurality of flexible castellations 328 is between three and ten. In the illustrated embodiment of FIG. 4, the adapter 300 includes four flexible castellations 328. Further, in some embodiments, each of the plurality of slots 330 is U-shaped. The slots 330 may extend from the first adapter end 304 towards the at least one second coupling element 312. In the illustrated embodiment of FIG. 4, the adapter 300 includes four slots 330.

In some embodiments, each of the plurality of flexible castellations 328 includes a wedge surface 332 forming a portion of the inner surface 308 and tapering outwardly in a direction D3 from the second adapter end 306 towards the first adapter end 304. In the illustrated embodiment of FIG. 4, the adapter 300 includes multiple wedge surfaces 332. A total number of the wedge surfaces 332 corresponds to a total number of the plurality of flexible castellations 328. The at least one second coupling element 312 may be spaced apart from the wedge surface 332 relative to the adapter axis A4. In some embodiments, the wedge surfaces 332 are spaced apart from the at least one second coupling element 312 by a portion of the inner surface 308. However, in other examples, it may be contemplated that the wedge surfaces 332 may extend up to the at least one second coupling element 312.

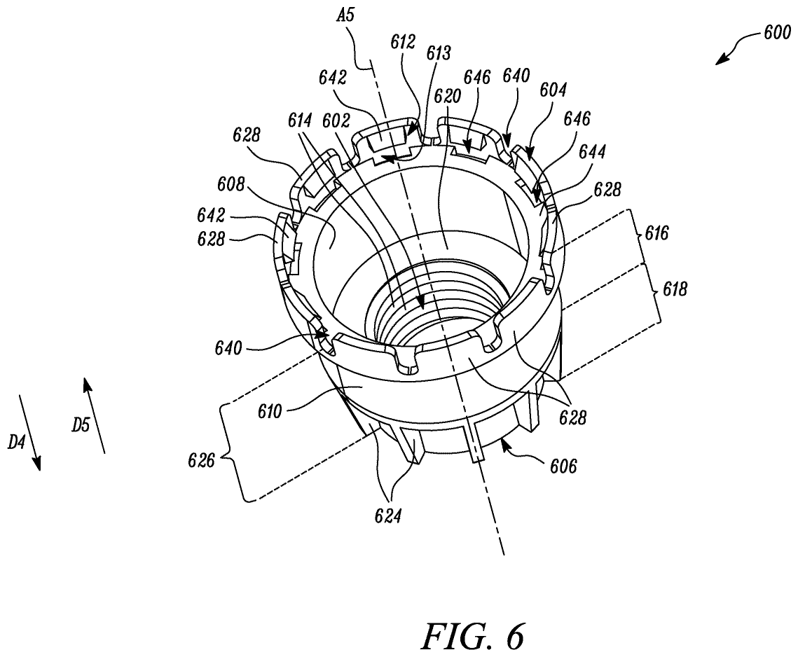

FIG. 6 illustrates an adapter 600 connectible with the fluid nozzle 100 of FIG. 1A, according to another embodiment of the present disclosure. Referring to FIGS. 1A and 6, the adapter 600 is configured to be selectively and removably connected to the third portion 130 of the tube 102 when the first fluid source 202 (see FIG. 2) is disconnected from the second portion 126 of the tube 102. The adapter 600 includes a generally circular cross-section that corresponds to the circular cross-section of the cylindrical section 132 of the third portion 130. The adapter 600 defines an adapter channel 602 that is in fluid communication with the fluid passageway 114 when the adapter 600 is connected to the third portion 130 of the tube 102. The adapter 600 is configured to be detachably connected to the second fluid source 702 (shown in FIG. 7) different from the first fluid source 202. The adapter 600 includes a first adapter end 604, a second adapter end 606 opposite to the first adapter end 604, an adapter axis A5 extending between the first adapter end 604 and the second adapter end 606, an inner surface 608, and an outer surface 610. The adapter 600 is configured to at least partially receive the third portion 130 of the tube 102 therein through the first adapter end 604.

The adapter 600 includes at least one second coupling element 612 disposed on the inner surface 608 proximal to the first adapter end 604 and extending angularly about the adapter axis A5. The at least one second coupling element 612 is configured to at least partially receive the at least one first coupling element 134 of the third portion 130 therein to form a snap-fit connection between the adapter 600 and the third portion 130. In the illustrated embodiment of FIG. 6, the adapter 600 includes a single second coupling element 612. However, the adapter 600 may include multiple second coupling elements (similar to the second coupling element 612).

Further, the tube 102 is rotatable relative to the adapter 600 about the tube axis Al upon connection with the adapter 600. The first coupling element 134 and the second coupling element 612 may form a fluid-tight connection between the tube 102 and the adapter 600, while allowing the tube 102 to rotate relative to the adapter 600 about the tube axis A1.

The adapter 600 may include one or more internal threads 614 extending from the second adapter end 606. The one or more internal threads 614 of the adapter may be configured to be threadably connected to the second fluid source 702. In some embodiments, the adapter 600 further includes a wide portion 616 disposed proximal to the first adapter end 604 and extending along the adapter axis A5. In some embodiments, the adapter 600 further includes a narrow portion 618 extending along the adapter axis A5 from the second adapter end 606 and including the one or more internal threads 614. The narrow portion 618 may define the adapter channel 602 that is in fluid communication with the fluid passageway 114 when the adapter 600 is connected to the tube 102. The adapter channel 602 is further disposed in fluid communication with the second fluid source 702 upon connection of the adapter 600 with the second fluid source 702. The adapter channel 602 may therefore fluidly communicate the fluid passageway 114 of the tube 102 with the second fluid source 702 upon connection of the adapter 600 with the tube 102 and the second fluid source 702. In some embodiments, the adapter 600 further includes a stepped portion 620 connecting the narrow portion 618 to the wide portion 616.

In some embodiments, the adapter 600 further includes a plurality of tapered ribs 624 angularly spaced apart from each other and disposed on the outer surface 610. Each of the plurality of tapered ribs 624 may extend from the second adapter end 606 towards the first adapter end 604 along the adapter axis A5 and tapers in a direction D4 from the first adapter end 604 to the second adapter end 606. The tapered ribs 624 may be disposed on the narrow portion 618 of the adapter 600.

In some embodiments, the adapter 600 further includes an adapter body 626 and a plurality of flexible castellations 628 extending from the adapter body 626 along the adapter axis A5 and disposed at the first adapter end 604. The wide portion 616 extends from the stepped portion 620 up to the first adapter end 604, and includes the plurality of flexible castellations 628. Further, the adapter body 626 is defined by the narrow portion 618 and a section of the wide portion 616 and excludes the plurality of flexible castellations 628.

In some embodiments, the plurality of flexible castellations 628 are angularly spaced apart from each other about the adapter axis A5 and define a plurality of slots 640 therebetween. Furthermore, each of the plurality of flexible castellations 628 may be configured to deform at least outwardly relative to the adapter axis A5 during the connection of the third portion 130 with the adapter 600. Moreover, in some embodiments, the at least one second coupling element 612 is disposed adjacent to the plurality of flexible castellations 628 opposite to the first adapter end 604. In some embodiments, a number of the plurality of flexible castellations 628 is between three and ten. In the illustrated embodiment of FIG. 6, the adapter 600 includes ten flexible castellations 628. Further, in some embodiments, each of the plurality of slots 640 is U-shaped. The slots 640 may extend from the first adapter end 604 up to the at least one second coupling element 612. In the illustrated embodiment of FIG. 6, the adapter 600 includes ten slots 630.

In some embodiments, the at least one second coupling element 612 includes a plurality of wedges 642 corresponding to the plurality of flexible castellations 628 and an annular shoulder 644 disposed adjacent to the plurality of flexible castellations 628 opposite to the first adapter end 604 and spaced apart from the plurality of wedges 642 relative to the adapter axis A5. Each of the plurality of wedges 642 may be disposed on a corresponding flexible castellation 628 from the plurality of flexible castellations 628 and tapers outwardly in a direction D5 from the second adapter end 606 towards the first adapter end 604. In some embodiments, the at least one second coupling element 612 further includes a discontinuous groove 613 defined between the plurality of wedges 642 and the annular shoulder 644. In some embodiments, the at least one second coupling element 612 may include one or more L-shaped grooves that may receive a corresponding first coupling element 134 of the third portion 130 for removably coupling the tube 102 with the adapter 600. It should be noted that the present disclosure is not limited by a shape or a design of the second coupling element 612. In some embodiments, the first coupling element 134 may include a groove and the second coupling element 612 may include an annular rib, a projection, a boss, and the like. It should be noted that the adapter 600 and the tube 102 may be detachably connected to each other by any complementary set of coupling elements.

Moreover, the annular shoulder 644 may include a plurality of openings 646 extending from the annular shoulder 644. Further, each opening 646 may be in alignment with a corresponding wedge 642. In some examples, a number of the openings 646 may correspond to the number of the flexible castellations 628. In the illustrated embodiment of FIG. 6, the adapter 600 includes ten openings 646.

FIG. 7 illustrates a schematic cross-sectional view of a fluid system 700, according to an embodiment of the present disclosure. The fluid system 700 includes the fluid nozzle 100 of FIG. 1A, the adapter 300 explained in reference to FIGS. 3, 4, and 5, and the second fluid source 702. Further, the fluid nozzle 100 is rotatably connected to the adapter 300 herein. As a result, the manifold 104 may be disposed in any desired orientation simply by rotating the fluid nozzle 100 relative to the adapter 300. The second fluid source 702 is detachably connected to the adapter 300. The second fluid source 702 is embodied as a single barrel cartridge unit herein. The second fluid source 702 may include a vessel 704 configured to contain the fluid F1. The fluid Fl can include any suitable material or materials, e.g., seam sealers, epoxies, foams, adhesives (e.g., adhesives), fillers, etc. Further, any suitable seam sealing materials may be utilized, e.g., seam sealers, urethane sealers, modified saline polymer sealers, epoxy sealers, acrylic sealers, viscus moisture sealants, UV-cure sealants, blue-light-cure sealants, heat activated sealants, etc. Furthermore, any suitable adhesives may be utilized, e.g., acrylic adhesives, etc. In one or more embodiments, the fluid F1 may include a seam sealing composition that is adapted to seal one or more seams disposed between panels of a vehicle or boat, or to seal seams present on interior or exterior surfaces of buildings.

Further, the second fluid source 702 may include a cylindrical projection 708 that is in fluid communication with the vessel 704. The second fluid source 702 may include a plunger 710. The plunger 710 may be utilized to force the fluid F1 towards the tube 102. Alternatively, the second fluid source 702 may not include the plunger 710, and the fluid F1 may be forced towards the tube 102 by applying pressure on the vessel 704, e.g., by squeezing the vessel 704.

The adapter 300 is threadably connected to the second fluid source 702. More particularly, the internal threads 314 of the adapter 300 may engage with external threads (not shown) on the cylindrical projection 708 for connecting the adapter 300 with the second fluid source 702. It should be noted that the present disclosure is not limited by a technique of connecting the adapter 300 with the second fluid source 702.

The fluid system 700 may be coupled with an applicator gun (not shown) for accomplishing a seam sealing application. The applicator gun may include any conventional sprayable seam sealer applicator gun manufactured such as those manufactured by 3M company (Saint Paul, MN, USA). The applicator gun may include a rod that may push the plunger 710 of the first fluid source 702 for directing the fluid F1 towards the fluid nozzle 100. Further, the applicator gun may be in communication with the air source. The applicator gun may be further connected to the manifold 104 by the air supply hose. A movement of the rods and a rate of air supply into the manifold 104 may be controlled by the applicator gun. The applicator gun may have a trigger. A partial squeeze of the trigger to a first position may allow passage of air towards the manifold 104. Further, a full squeeze of the trigger to a second position activates the rod to push the fluid F1 towards the fluid nozzle 100. The fluid F1 may be directed into the fluid nozzle 100 via the inlet 110 and the adapter channel 302. Moreover, the fluid Fl may be ejected through the outlet 112 of the fluid nozzle 100.

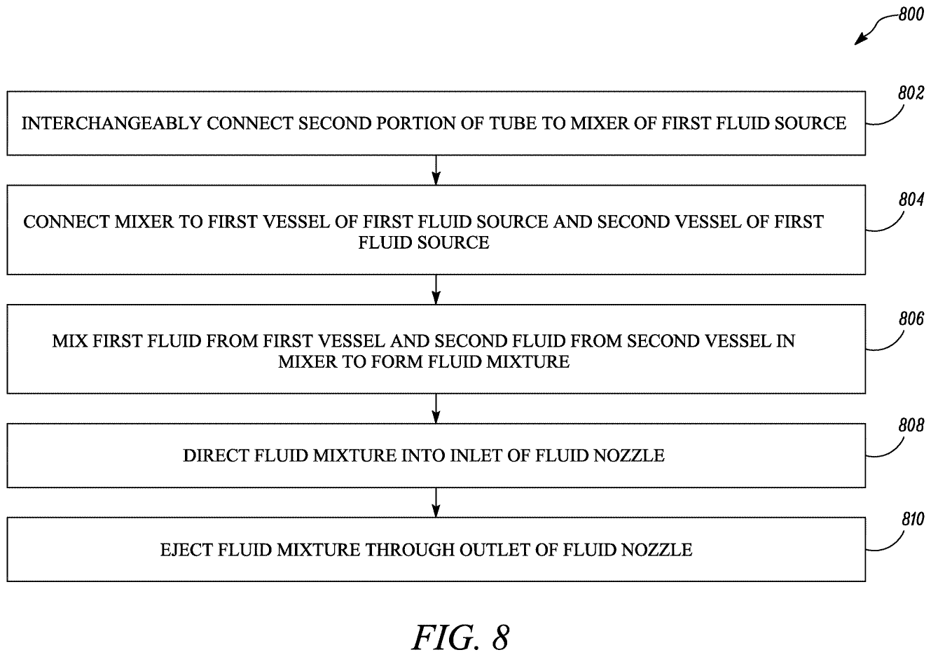

FIG. 8 illustrates a flowchart for a method 800 of using the fluid nozzle 100. Referring to FIGS. 2 and 8, at step 802, the second portion 126 of the tube 102 is interchangeably connected to the mixer 204 of the first fluid source 202. At step 804, the mixer 204 is connected to the first vessel 216 of the first fluid source 202 and the second vessel 218 of the first fluid source 202. At step 806, the first fluid F3 from the first vessel 216 and the second fluid F4 from the second vessel 218 are mixed in the mixer 204 to form the fluid mixture F2. At step 808, the fluid mixture F2 is directed into the inlet 110 of the fluid nozzle 100. At step 810, the fluid mixture F2 is ejected through the outlet 112 of the fluid nozzle 100.

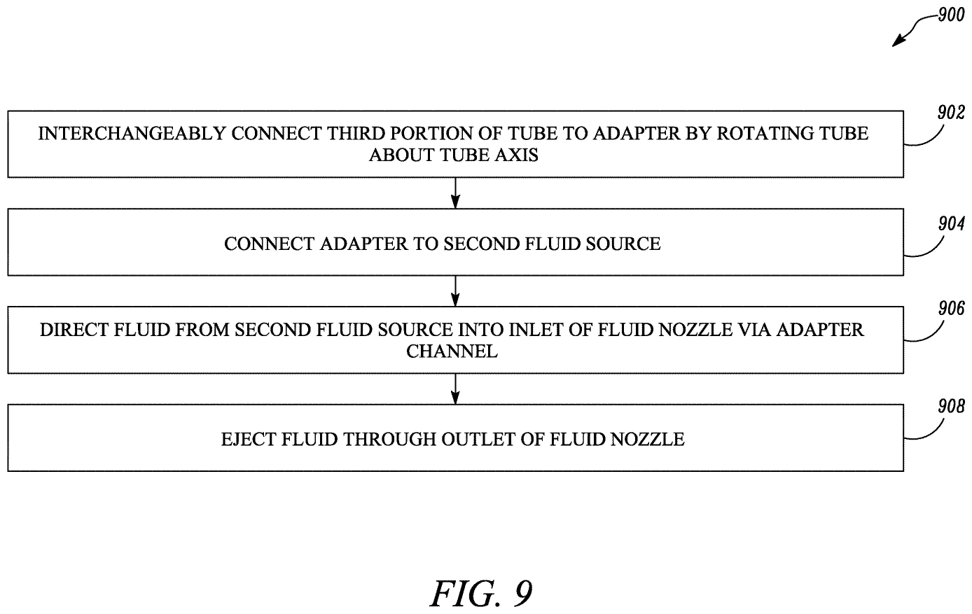

FIG. 9 illustrates a flowchart for a method 900 of using the fluid nozzle 100. Referring to FIGS. 7 and 9, at step 902, the third portion 10 of the tube 102 is interchangeably connected to the adapter 300 by rotating the tube 102 about the tube axis A1. At step 904, the adapter 300 is connected to the second fluid source 702. At step 906, the fluid F1 from the second fluid source 702 is directed into the inlet 110 of the fluid nozzle 100 via the adapter channel 302. At step 908, the fluid F1 is ejected through the outlet 112 of the fluid nozzle 100.

Thus, the fluid nozzle 100 may be interchangeably connected to the first fluid source 202 containing a two fluid component as well as the second fluid source 702 containing a single fluid component, thereby reducing part numbers and increasing efficiency of the fluid systems 200, 700, respectively. Further, the fluid nozzle 100 may be interchangeably connected to the first fluid source 202, via the mixer 204, and the second fluid source 702, via the adapter 300, 600 (see FIGS. 4 and 6), without making any changes to the structure of the fluid nozzle 100. Furthermore, the present disclosure may reduce the number of applicators (and more specifically, fluid nozzles) required to perform seam sealing applications for replicating OEM look and appearance, while increasing application efficiency, reducing waste, and creating a unique, no clean up solution for the fluid systems 200, 700.

As the modular fluid nozzle 100 may be connected with two different fluid sources 202, 702, costs associated with handling and manufacturing of fluid nozzles with different part numbers may be eliminated. Further, the fluid nozzle 100 may be disposable, thereby eliminating time required for cleaning and additional costs associated with cleaning solutions. Moreover, the fluid nozzle 100 may be connectable with different designs of air manifolds and nozzle spray tips.

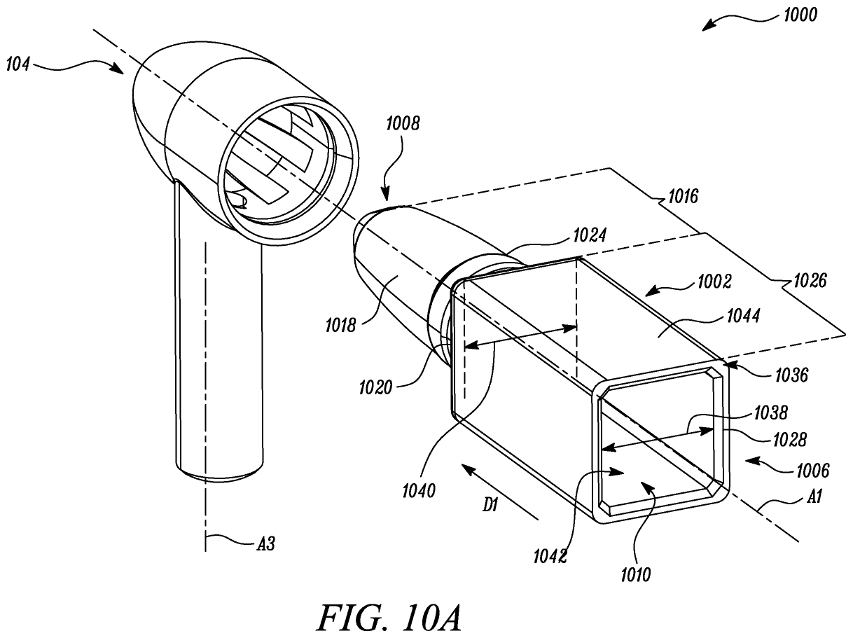

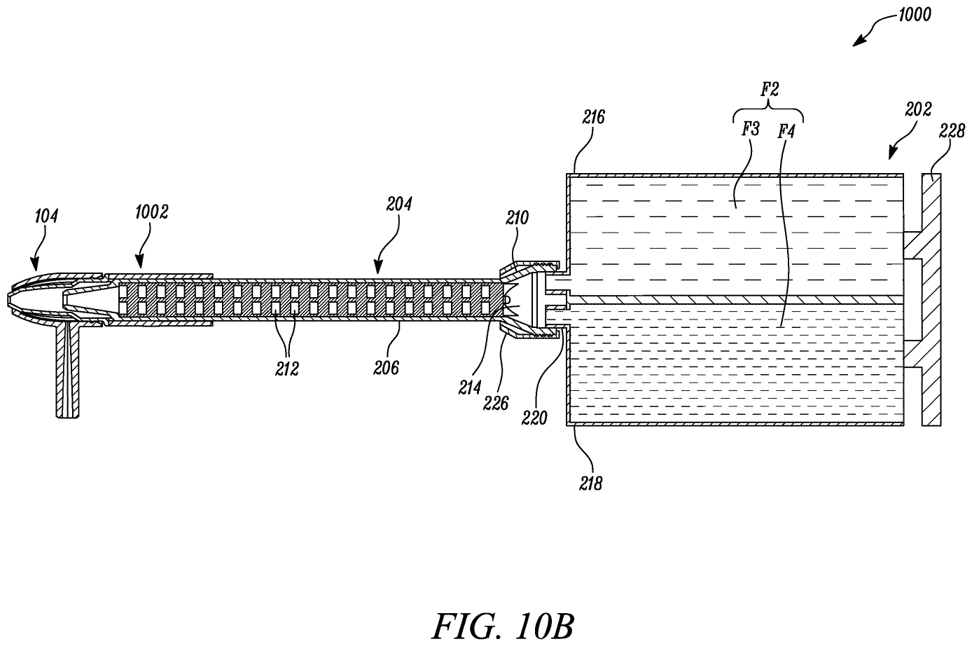

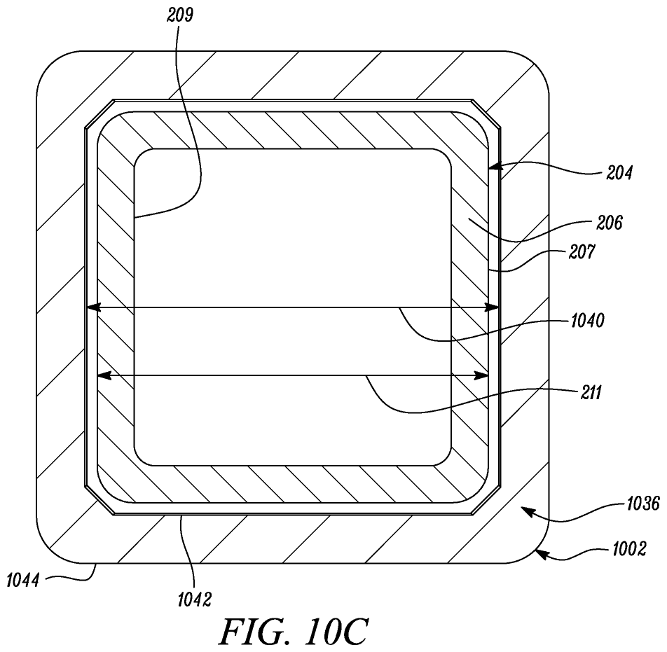

FIG. 10A-10B illustrate a fluid system 1000 including the manifold 104 that is attached to the tube 1002. The tube 1002 can fit over the mixer 204 in a fluid-tight manner. The tube 1002 can be similar to tube 102 except that the 1002 may lack a third portion extending from the wall of the second portion 1026.

For example, the tube 1002 can have a first tube end 1006 and a second tube end 1008 opposite from the first tube end 1006. A fluid passageway can extend from an inlet 1010 at the first tube end 1006 to an outlet at the second tube end 1008. The tube 1002 can have a first portion 1016 and a second portion 1026.

The first portion 1016 extends from the second portion 1026 towards the second tube end 1008 along the tube axis A1. In some embodiments, the first portion 1016 includes the tapering portion 1018 having a tapering cross-section along the flow direction D1. The tapering portion 1018 can lead to a continuous rib 1024 upstream from the flow direction. In at least one embodiment, the continuous rib 1024 can be arranged on the uniform portion 1020 and protrude from the uniform portion 1020 thereon. The continuous rib 1024 can be configured to catch an inner surface of the manifold 104 such that the continuous rib 1024 acts like a retention mechanism for the manifold 104. The inner surface of the manifold 104 can also include discontinuous axial ribs arranged along the axis Al such that the flow of the fluid is laminar.

The second portion 1026 can extend from the uniform portion 1020 to the first tube end 1006. In some examples, an inner cross-sectional area of the second portion 1026 may be greater than an average cross-sectional area of the first portion 1016. In some embodiments, the second portion can include a wall having a polygonal shape 1028 with vertexes 1036. The second portion 1026 can taper along the flow direction. For example, the (inner) dimension 1038 (e.g., the inner diameter from vertex to vertex in a plane perpendicular to axis A1) can be greater than the dimension 1040. It was found that the tapering along with the chamfered vertexes can result in a more secure interference fit with the mixer tube 206. The tube 1002 can have an inner surface 1042 and an outer surface 1044. In at least one embodiment, the inner surface 1042 can cause a friction or interference fit with the outer dimension of the mixer tube 206. As shown in FIG. 10C, the mixer tube 206 can have an inner surface 209 and an outer surface 207. The dimension 211 can be an outer dimension measured from one vertex on the outer surface 207 to another vertex on the opposite outer surface 207. In some embodiments, the dimension 211 can be a diameter. In at least one embodiment, the dimension 1040 can be smaller than dimension 211 such that the mixer tube 206 undergoes slight compression along the perimeter. In at least one embodiment, the dimension 1038 can be slightly larger than the dimension 211. In at least one embodiment, the outer surface 207 can be dimensioned relative to the inner surface 1042 such that there is an interference fit between the mixer tube 206 and the tube 1002. For example, 5 thousandths of an inch (0.127 mm) to 50 thousandths of an inch (1.27 mm) interference.

In at least one embodiment, the outer surface 1044 of the wall is continuous without protrusions. The cross-sectional shape of the second portion 1026 in a plane perpendicular to the axis Al is continuous along the second portion. This differs from tube 102, having a third portion 130 which has a different cross-sectional shape from the section including the second portion 1026. Such a configuration can be more streamlined and reduce material use.

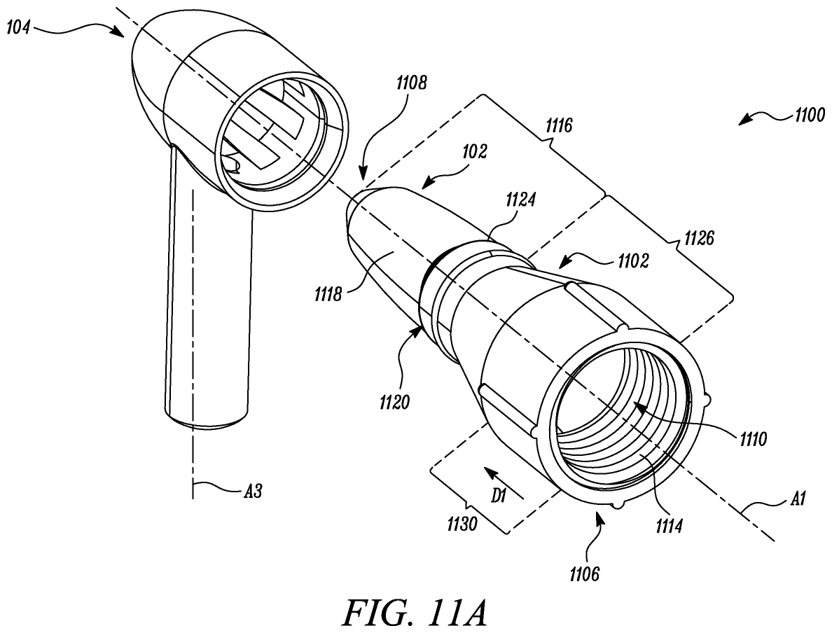

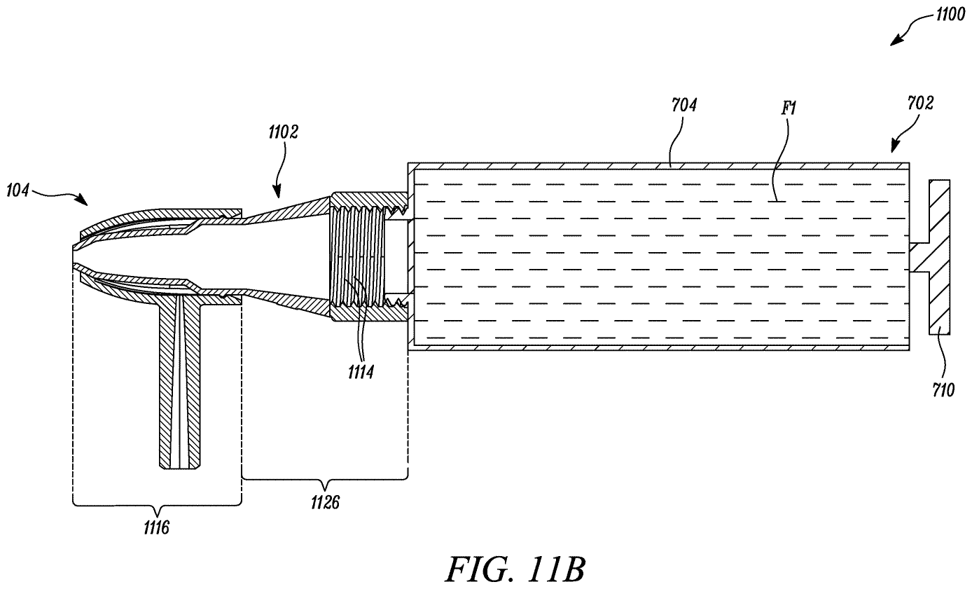

FIG. 11A-11B illustrate a system 1100 comprising a tube 1102 that is configured to couple to the manifold 104 and the second fluid source 702 (as described in FIG. 7). The tube 1102 can differ from the tube 102 in that the tube 1002 can directly couple (e.g., via threading 1114) to the second fluid source 702.

The tube 1102 can be a single integral component. The tube 1102 includes a first tube end 1106 and a second tube end 1108 opposite to the first tube end 1106. The tube 1102 extends along a tube axis Al defined between the first tube end 1106 and the second tube end 1108. The tube 1102 includes an inlet 1110 at the first tube end 1106. A fluid F1 may be received within the tube 1102 via the inlet 1110. The tube 1102 further includes an outlet defined at the second tube end 1108. The tube 1102 further includes a fluid passageway disposed within the tube 1102 and extending from the inlet 1110 to the outlet. The tube 1102 can also have threading 1114 integrated into the tube 1102 at the tube end 1106.

The tube 1102 can have a first portion 1116 and a second portion 1126 (proximate to the threading 1114 or other attachment mechanism). The first portion 1116 can be proximate to the tube end 1108. The first portion 1116 can include the uniform portion 1120 having a continuous rib 1124 for attachment to the manifold 104. The first portion 1116 can also include the tapering portion 1118. In at least one embodiment, the tapering portion 1118 can lead to a continuous rib 1124 upstream from the flow direction. The continuous rib 1124 can further lead to a uniform portion 1120.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components, or layers for example.

Various examples have been described. These and other examples are within the scope of the following claims.

1. A fluid nozzle comprising:
a tube comprising a first tube end and a second tube end opposite to the first tube end, the tube extending along a tube axis defined between the first tube end and the second tube end, the tube comprising:
an inlet defined at the first tube end;
an outlet defined at the second tube end;
a fluid passageway disposed within the tube and extending from the inlet to the outlet;
a first portion comprising the outlet, the first portion extending from the second tube end towards the first tube end along the tube axis, the first portion at least partially defining the fluid passageway therein;
a second portion comprising the inlet, the second portion extending from the first portion to the first tube end along the tube axis, the second portion at least partially defining the fluid passageway therein, wherein the second portion is configured to be selectively and removably connected to a first fluid source or a mixer; and
a manifold configured to be detachably connected to the first portion of the tube by a snap-fit connection.

2. The fluid nozzle of claim 1, wherein the first fluid source is a two-component adhesive, wherein the second portion of the tube is configured to couple to a static mixing nozzle via a friction fit.

3. The fluid nozzle of claim 1, wherein the static mixing nozzle comprises one or more internal threads extending from the second tube end, and wherein the one or more internal threads are configured to be threadably connected to the first fluid source.

4. The fluid nozzle of claim 1, wherein the first fluid source is a one-component adhesive, and wherein the one or more internal threads of the second tube end are configured to be threadably connected to the first fluid source.

5. The fluid nozzle of claim 1, the tube further comprising: a third portion extending from the first tube end towards the second tube end along the tube axis, the third portion at least partially surrounding and connected to the second portion, the third portion comprising a cylindrical section extending along a length of the third portion and at least one first coupling element disposed on the cylindrical section; and, wherein the fluid nozzle further comprises:
an adapter configured to be selectively and removably connected to the third portion of the tube when the first fluid source is disconnected from the second portion of the tube, wherein the adapter defines an adapter channel that is in fluid communication with the fluid passageway when the adapter is connected to the third portion of the tube, wherein the adapter is configured to be detachably connected to a second fluid source different from the first fluid source, the adapter comprising a first adapter end, a second adapter end opposite to the first adapter end, an adapter axis extending between the first adapter end and the second adapter end, an inner surface, and an outer surface, wherein the adapter is configured to at least partially receive the third portion of the tube therein through the first adapter end, the adapter comprising at least one second coupling element disposed on the inner surface proximal to the first adapter end and extending angularly about the adapter axis, wherein the at least one second coupling element is configured to at least partially receive the at least one first coupling element of the third portion therein to form a snap-fit connection between the adapter and the third portion, and wherein the tube is rotatable relative to the adapter about the tube axis upon connection with the adapter.

6. The fluid nozzle of claim 5, wherein the adapter further comprises an adapter body and a plurality of flexible castellations extending from the adapter body along the adapter axis and disposed at the first adapter end, wherein the plurality of flexible castellations are angularly spaced apart from each other about the adapter axis and define a plurality of slots therebetween, and wherein each of the plurality of flexible castellations is configured to deform at least outwardly relative to the adapter axis during the connection of the third portion with the adapter.

7. The fluid nozzle of claim 6, wherein each of the plurality of slots is U-shaped.

8. The fluid nozzle of claim 6, wherein the at least one second coupling element is disposed adjacent to the plurality of flexible castellations opposite to the first adapter end.

9. The fluid nozzle of claim 6, wherein the at least one second coupling element comprises a plurality of wedges corresponding to the plurality of flexible castellations and an annular shoulder disposed adjacent to the plurality of flexible castellations opposite to the first adapter end and spaced apart from the plurality of wedges relative to the adapter axis, each of the plurality of wedges disposed on a corresponding flexible castellation from the plurality of flexible castellations and tapering outwardly in a direction from the second adapter end towards the first adapter end, wherein the at least one second coupling element further comprises a discontinuous groove defined between the plurality of wedges and the annular shoulder.

10. The fluid nozzle of claim 9, wherein each of the plurality of flexible castellations comprises a wedge surface forming a portion of the inner surface and tapering outwardly in a direction from the second adapter end towards the first adapter end, and wherein the at least one second coupling element is spaced apart from the wedge surface relative to the adapter axis.

11. The fluid nozzle of claim 1, wherein the adapter further comprises a plurality of longitudinal ribs angularly spaced apart from each other about the adapter axis, each of the plurality of longitudinal ribs extending from the first adapter end towards the second adapter end along the adapter axis.

12. The fluid nozzle of claim 3, wherein the adapter comprises one or more internal threads extending from the second adapter end, and wherein the one or more internal threads of the adapter are configured to be threadably connected to the second fluid source.

13. The fluid nozzle of claim 1, wherein the adapter further comprises:
a wide portion disposed proximal to the first adapter end and extending along the adapter axis;
a narrow portion extending along the adapter axis from the second adapter end and comprising the one or more internal threads; and
a stepped portion connecting the narrow portion to the wide portion.

14. The fluid nozzle of claim 1, wherein the adapter further comprises a plurality of tapered ribs angularly spaced apart from each other and disposed on the outer surface, and wherein each of the plurality of tapered ribs extends from the second adapter end towards the first adapter end along the adapter axis and tapers in a direction from the first adapter end to the second adapter end.

15. The fluid nozzle of claim 1, wherein the fluid nozzle does not include a plurality of baffle elements to thoroughly mix materials passing through the tube.

16. The fluid nozzle claim 1, wherein the second portion comprises a polygonal shape along a length of the second portion.

17. The fluid nozzle of claim 5, wherein the third portion is connected at least to each vertex of the polygonal shape of the second portion along the length of the third portion.

18. The fluid nozzle of claim 1, wherein the first portion at least partially tapers in a flow direction from the first tube end to the second tube end.

19. The fluid nozzle of claim 1, wherein the manifold comprises:
a first tubular portion extending along a first axis and configured to at least partially receive the first portion of the tube therein, wherein the first tubular portion defines an air outlet that is disposed around the outlet of the tube; and
a second tubular portion extending from the first tubular portion along a second axis inclined to the first axis, the second tubular portion defining an air inlet disposed in fluid communication with the first tubular portion.

20. The fluid nozzle of claim 1, wherein the second portion comprises a polygonal shape along a length of the second portion, wherein the second portion comprises a vertex, wherein the vertex is chamfered.

21.-24. (canceled)
